(19) United States
(12) Patent Application Publication
(10) Pub. No.: US 2021/0200192 A1
(43) Pub. Date: Jul. 1, 2021

(54) METHOD AND SYSTEM FOR DISPLAYING A 3D MODEL

(71) Applicant: Siemens Aktiengesellschaft, München (DE)

(72) Inventors: Rebecca Johnson, München (DE); Asa MacWilliams, Fürstenfeldbruck (DE); Robert Wilde, München (DE)

(21) Appl. No.: 17/056,812

(22) PCT Filed: May 9, 2019
(86) PCT No.: PCT/EP2019/061889

§ 371 Date: Nov. 19, 2020

(30) Foreign Application Priority Data
May 22, 2018 (DE) 102018207987.0

(51) Int. Cl. G05B 19/418; G06T 19/00

(52) U.S. Cl. CPC G05B 19/41805; G06T 19/00; G05B 19/41885

(57) ABSTRACT

The disclosure relates to a method for displaying a 3D model of an object, wherein the object includes a plurality of parts arranged in original positions. The method includes: actuating a control device by a user to select a selected region of the 3D model, wherein the parts of the object that are located in the selected region form the selected parts; and displaying the 3D model such that the selected parts are displayed in end positions in which they are moved away from their original positions such that distances between the selected parts increase. The selected parts are displayed such that a user may see the selected parts better.

The present patent document is a § 371 nationalization of PCT Application Serial No. PCT/EP2019/061889, filed May 9, 2019, designating the United States, which is hereby incorporated by reference, and this patent document also claims the benefit of German Patent Application No. 10 2018 207 987.0, filed May 22, 2018, which is also hereby incorporated by reference.

### TECHNICAL FIELD

The present disclosure relates to a method for displaying a 3-D model of an object and to a system for displaying such a 3-D model of an object.

### BACKGROUND

In virtual reality environments and/or augmented reality environments, an object may be displayed as a 3-D model, for example. It may be desirable for a user to look at the individual parts of the object in the 3-D model in order to understand, for example, how the parts are assembled. For this purpose, it is desirable to display the 3-D model in such a manner that a visualization of the individual parts of the displayed object is simplified.

### SUMMARY AND DESCRIPTION

Against this background, an object of the present disclosure is to provide an improved display of a 3-D model of an object. The scope of the present disclosure is defined solely by the appended claims and is not affected to any degree by the statements within this summary. The present embodiments may obviate one or more of the drawbacks or limitations in the related art.

A first aspect proposes a method for displaying a 3-D model of an object having a multiplicity of parts arranged in original positions. The method includes actuating a control device by a user in order to select a selected region of the 3-D model, wherein the parts of the object which are in the selected region form selected parts. The method further includes displaying the 3-D model in such a manner that the selected parts are displayed in end positions in which they are moved away from their original positions in such a manner that distances between the selected parts increase.

A visualization of the selected parts may be simplified by displaying the selected parts in end positions. Because the distances between the selected parts are increased, the selected parts are more visible, in particular. The display of the 3-D model may be dynamically and interactively changed by actuation of the control device by a user. A display of the 3-D model may therefore be improved.

This improved display of the 3-D model may make it possible for the user to better locate a particular part of the object, for example, a particular screw. The user may also better locate a machine in a 3-D model of a complex industrial installation on the basis of the display. The user may therefore “see into” the object, in particular. Furthermore, the user may better discern how the selected parts are assembled. This allows the user to better understand, for example, how the object functions.

The object may include a device of an industrial installation, for example, an electric motor. The object may be both an electronic device and a mechanical object. The object may also be an industrial installation having a plurality of machines.

The 3-D model is, in particular, a 3-D representation of the object. The 3-D model may form a realistic representation of the object. The 3-D model may be a CAD model.

The multiplicity of parts are assembled, in particular, in such a manner that they form the object or a part of the object. The parts are, for example, screws, cylinders, housing parts, valves, pistons, or the like. However, the parts may also be entire machines, for example motors or machines of an industrial installation.

The original positions of the parts may be positions in which the parts are assembled in order to form the object or a part of the latter. The display of the object with its parts in the original positions corresponds, in particular, to a truthful and/or realistic display of the object.

The control device is actuated, for example, by virtue of the user moving the control device and/or actuating a button of the control device. In embodiments, the control device may also detect movements of the user and may be actuated thereby. For this purpose, the control device may be in the form of a motion sensor.

The selected region of the 3-D model is, for example, a 3-D region of the 3-D model. The selected region is, in particular, that region of the object which the user would like to visualize in detail. The selected region is spherical or cuboidal, for example. The parts of the object which are in the selected region form the selected parts, in particular.

The selection of the selected region results, in particular, in the selected parts being displayed in end positions instead of in their original positions. The end positions of the selected parts differ from their original positions, in particular. In the end positions, the selected parts may be displayed in such a manner that distances between the selected parts increase. The distances between the selected parts are greater, in particular, if the parts are in the end positions than if they are in the original positions. The selected parts are displayed in a 3-D exploded view, in particular.

According to one embodiment, the 3-D model is displayed in such a manner that the parts of the object which are outside the selected region are displayed in their original positions.

In particular, only the selected parts are displayed in original positions. The selected parts may therefore be highlighted in comparison with the parts which have not been selected outside the selected region. This makes it possible to further improve the display of the 3-D model.

According to a further embodiment, the selected parts are moved away from their original positions when displaying the 3-D model in such a manner that distances between the selected parts and a reference point inside the selected region increase. The reference point is situated centrally in the selected region, in particular.

The extent by which the distance between a selected part and the reference point is increased is proportional, in particular, to the distance between the reference point and the selected part in its original position. The selected parts which are close to the reference point in their original positions are therefore moved to a lesser extent, in particular, than the selected parts which are further away from the reference point in their original positions.

According to a further embodiment, the 3-D model is displayed in a virtual reality environment (VR environment) and/or in an augmented reality environment (AR environment).

The 3-D model is displayed, in particular, in an environment in which it is displayed together with additional information, for example, predetermined text or a predetermined image. The 3-D model may also be displayed on a 3-D screen. This may be a 3-D screen of a headset, in particular, of a VR headset or an AR headset.

According to a further embodiment, the control device emits virtual beams in such a manner that they are visible only in the VR environment and/or in the AR environment and are used to select the selected region during movement of the control device.

The virtual beams are, in particular, beams which are visible only in the VR and/or AR environment. They are visible only to a user having a corresponding headset, for example. In the VR and/or AR environment, the virtual beams may resemble the light beams from a flashlight.

When selecting the selected region, the user directs the virtual beams, for example, in the direction of that region of the object which the user would like to select. When selecting the selected region, the user directs the virtual beams onto the 3-D model representation of the object, in particular.

According to a further embodiment, the virtual beams are emitted by the control device in the form of truncated cones in the VR environment and/or the AR environment, and a region of the object which is intersected by the virtual beams forms the selected region.

According to a further embodiment, the reference point is arranged on a central axis of a truncated cone formed by the beams in the form of truncated cones.

According to a further embodiment, the control device is actuated in such a manner that: a position of the reference point is selected; a distance between the control device and the reference point is selected; an extent of the increase in the distances between the selected parts is selected; and/or a size of the selected region is determined.

The position of the reference point may be selected by moving the control device. The distance between the control device and the reference point is selected, in particular, by actuating an adjustment unit on the control device. The extent of the increase in the distances between the selected parts may be selected by a further adjustment unit on the control device. In addition, the size of the selected region may be changed, for example, by determining an opening angle of the truncated cone.

According to a further embodiment, the method also includes actuating the control device by the user in such a manner that the selection of the selected region is canceled. The method further includes displaying the 3-D model in such a manner that the parts of the previously selected region are displayed in their original positions.

The selection of the selected region is canceled, in particular, by the user actuating the control device again, for example, by moving it away from the selected region. In embodiments, the user selects a new selected region when actuating and/or moving the control device. The newly selected parts of the new selected region may then be displayed in end positions in which they are moved away from their original positions in such a manner that distances between the newly selected parts increase.

According to a further embodiment, the method also includes selecting a predetermined part of the selected parts by the control device and/or a further control device.

The user may select one of the selected parts, in particular, and may look at it in more detail, for example. The user may also acquire properties of the predetermined part. The predetermined part may be advantageously selected without the user knowing the name of the part or its hierarchy.

According to a further embodiment, the 3-D model is displayed in such a manner that a transparency of at least some of the parts of the object, in particular, of the parts which have not been selected, is increased.

The remaining parts may be visualized better by increasing the transparency of some parts of the object. If the transparency of the parts which have not been selected is increased, the selected parts may be viewed better without the parts which have not been selected concealing the selected parts.

A computer program product which causes the method explained above to be carried out on a program-controlled device is also proposed.

A computer program product, (e.g., a computer program means), may be provided or delivered, for example, as a storage medium, such as a memory card, a USB stick, a CD-ROM, a DVD or else in the form of a downloadable file from a server in a network. This may be carried out, for example, in a wireless communication network, by transmitting a corresponding file containing the computer program product or the computer program means.

A second aspect proposes a system for displaying a 3-D model of an object with a multiplicity of parts arranged in original positions. The system includes a control device configured to be actuated by a user in such a manner that a selected region of the 3-D model is selected, wherein the parts of the object which are in the selected region form selected parts. The system further includes a display device for displaying the 3-D model in such a manner that the selected parts are displayed in end positions in which they are moved away from their original positions in such a manner that distances between the selected parts increase.

The respective device, (e.g., the control device or the display device), may be implemented using hardware and/or software. In the case of a hardware implementation, the respective device may be in the form of an apparatus or part of an apparatus, for example, in the form of a computer or a microprocessor or a control computer of a vehicle. In the case of a software implementation, the respective device may be in the form of a computer program product, a function, a routine, part of a program code, or an executable object.

The embodiments and features described for the proposed method accordingly apply to the proposed system.

A third aspect proposes a control device for the system according to the second aspect or according to an embodiment of the second aspect for selecting a selected region of a 3-D model of an object when actuated by a user. The control device is in the form of a flashlight. The control device includes: an actuation unit for switching the control device on and off; an extent unit for selecting an extent of the increase in the distances between the selected parts; a selection unit for selecting a predetermined part of the selected parts; and/or a determination unit for determining a position and/or a size of the selected region.

The practice of designing the control device in the form of a flashlight is advantageous, in particular, because the control device may be gripped by a user and may be actuated using a single hand. Furthermore, the control device is actuated, in particular, in a similar manner to the actuation of a flashlight and is therefore intuitive.

The extent unit is, in particular, a sliding button. The determination unit may be in the form of a rotatable ring on the control device. However, the extent unit and the determination unit may also be in the form of buttons, for example. The position and/or size of the selected region may also be effected by voice control and/or text input via the determination unit.

Further possible implementations of the disclosure also include combinations, which have not been explicitly mentioned, of features or embodiments described above or below with respect to the exemplary embodiments. In this case, a person skilled in the art will also add individual aspects as improvements or additions to the respective basic form of the disclosure.

### BRIEF DESCRIPTION OF THE DRAWINGS

The exemplary embodiments which are described below relate to further advantageous configurations and aspects of the disclosure. The disclosure is explained in more detail below on the basis of certain embodiments with reference to the enclosed figures.

FIG. 1 depicts a first illustration of an example of a system for displaying a 3-D model;

FIG. 2 depicts a second illustration of the system for displaying a 3-D model.

FIG. 3 depicts an example of a displayed object.

FIG. 4 depicts a method for displaying a 3-D model according to a first embodiment.

FIG. 5 depicts a method for displaying a 3-D model according to a second embodiment.

FIG. 6 depicts a control device according to one exemplary embodiment.

In the figures, identical or functionally identical elements have been provided with the same reference signs unless stated otherwise.

### DETAILED DESCRIPTION

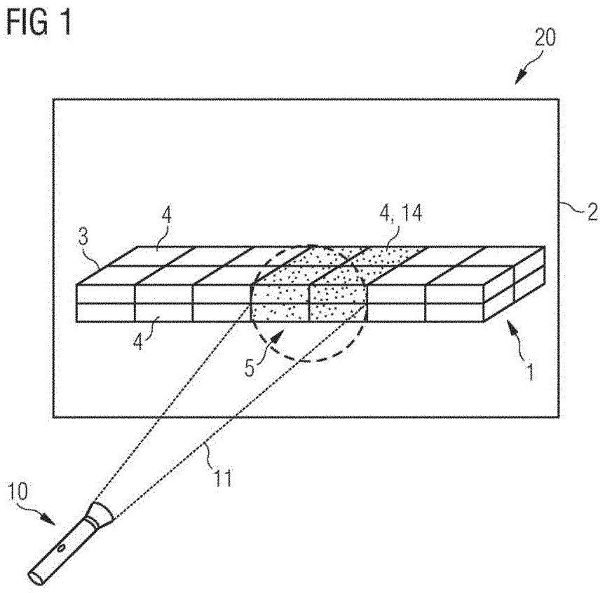

FIG. 1 depicts a system 20 for displaying a 3-D model 1. The system 20 includes a control device 10 and a display device 2. The display device 2 is a screen 2 of a VR headset (not illustrated) which may display 3-D images.

A 3-D model 1 of an object 3 is displayed on the screen 2 in FIG. 1. The 3-D model 1 is a representation of the object 3. In the present example, the object 3 is a motor of an industrial installation. The object 3 (e.g., motor) includes a multiplicity of parts 4, e.g., screws, cylinders, and pistons. For the sake of clarity, the parts 4 are schematically illustrated as blocks in FIG. 1. In addition, for the sake of clarity, only a few of the parts 4 are provided with reference signs in FIG. 1. However, the object 3 actually includes 28 parts 4. The parts 4 are displayed in their original positions in FIG. 1.

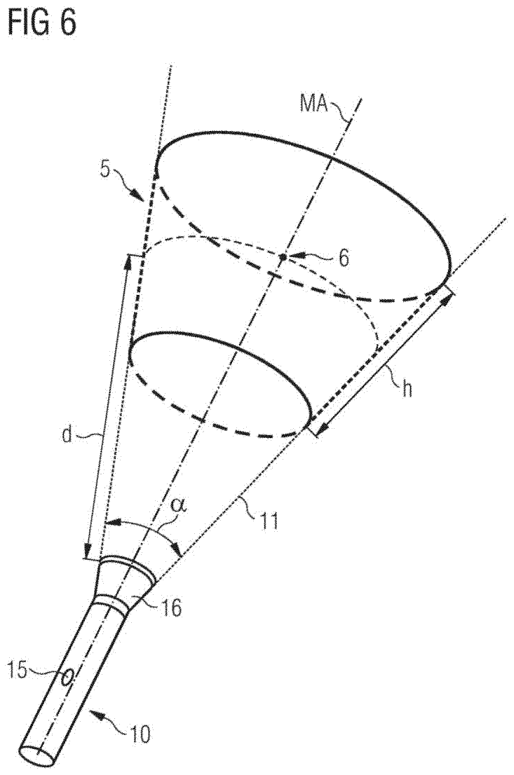

The control device 10 is in the form of a flashlight and is actuated by a user picking it up and moving it. The actuation of the control device 10 is explained in yet more detail below with reference to FIG. 6.

The system 20 is suitable for carrying out a method for displaying a 3-D model 1. Such a method is shown, for example, in FIG. 4 which shows a method for displaying a 3-D model 1 according to a first embodiment. The method is described below with reference to FIGS. 1, 2, 3, and 4.

In act S1, the control device 10 is actuated by a user 7 in order to select a selected region 5 of the 3-D model 1. For this purpose, the user 7 picks up 13 the control device 10 and moves it in such a manner that virtual beams 11, which are emitted by the control device 10, are emitted in the direction of the 3-D model 1. In this case, the virtual beams 11 are visible only in the VR environment, that is to say with the VR headset.

The user 10 moves the control device 10 in his hand 13 in such a manner that the virtual beams 11 emitted in the form of truncated cones intersect the object 3. The region of the object 3 within the beams 11 in the form of truncated cones forms the selected region 5. This is a region which the user 7 would like to visualize in more detail.

The parts 4 of the object 3 which are inside the selected region 5 form selected parts 14. The side surfaces of the selected parts 14 are illustrated using dotted lines in FIG. 1. In the example in FIG. 1, the selected region includes eight selected parts 14.

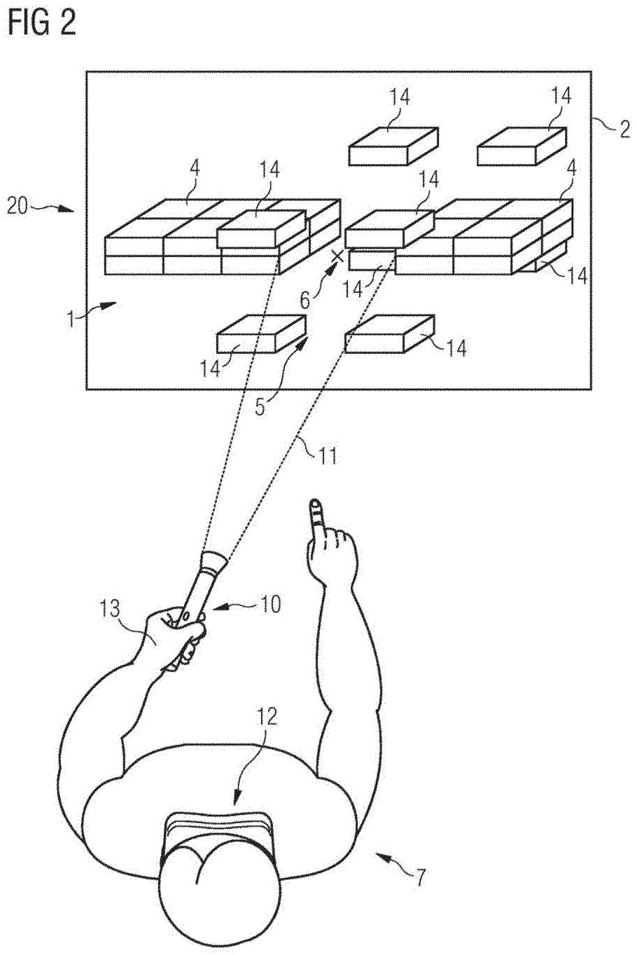

In act S2, the 3-D model 1 is displayed in such a manner that the selected parts 14 are displayed in end positions. FIG. 2 depicts how the selected parts 14 are displayed in the end positions. The selected parts 14 are moved away from their original positions (FIG. 1) in such a manner that distances between the individual selected parts 14 are increased. In this case, the selected parts are moved away from a reference point 6 which is in the center of the selected region 5. The parts 4 which have not been selected are still displayed in their original positions.

In his VR headset 12, the user 7 sees how the selected parts 14 “fly apart”. As a result, the user 7 may better see the selected parts 14. He also sees, in particular, the selected parts 14 which were previously concealed by other parts 4.

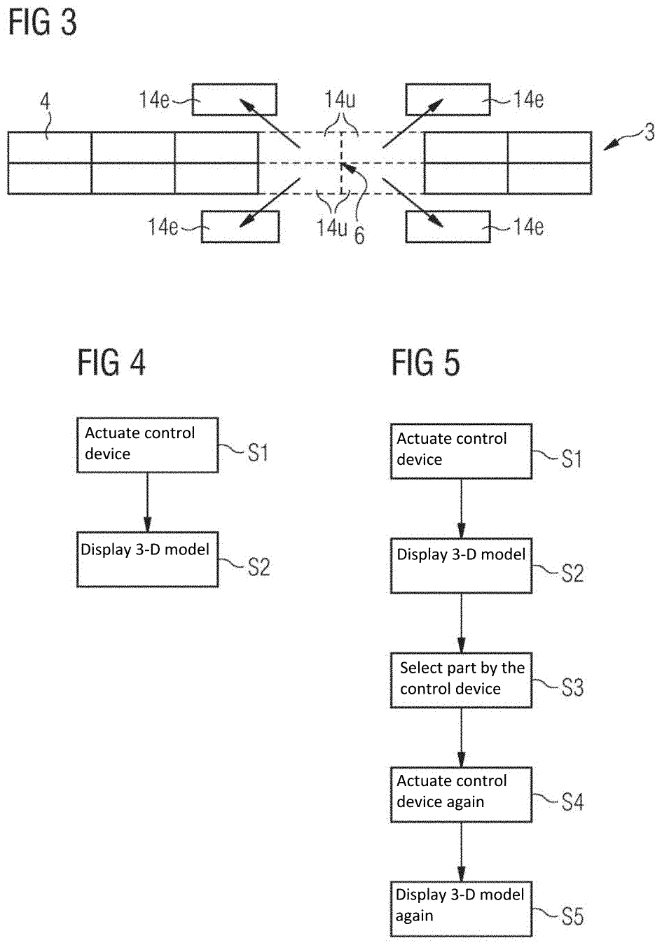

FIG. 3 schematically depicts how the selected parts 14 are moved. In FIG. 3, the reference signs 14u show the selected parts 14 which are in their original positions. The reference signs 14e show the selected parts 14 which are in their end positions.

The system 20 may alternatively also carry out a method for displaying a 3-D model 1 according to a second embodiment. Such a method is described below on the basis of FIG. 5.

In the method according to the second embodiment (FIG. 5), method acts S1 and S2 are identical to those of the method according to the first embodiment (FIG. 4). In act S3, the user 7 selects a predetermined part from the selected parts 14 by the control device 10. Properties of the predetermined part are displayed on the screen 2, with the result that the user 7 receives information relating to the predetermined part.

In act S4, the control device 10 is actuated by the user 7 again, with the result that the selection of the selected region 5 is canceled. For this purpose, the user 7 moves the control device 10 away from the selected region 5, with the result that the virtual beams 11 no longer intersect the object 3 in the selected region 5. In particular, the selected parts 14 are displayed in their end positions only as long as the user 7 points to the selected region 5 with the control device 10.

In act S5, the 3-D model 1 is displayed again in such a manner that the previously selected parts 14 are displayed in their original positions again. The previously selected parts 14 are moved together again, with the result that a distance between the respective previously selected parts 14 and the reference point 6 is reduced again.

Acts S1-S5 may be repeated as often as desired. As a result, the user 7 may select and investigate individual regions of the object 3 in succession.

FIG. 6 depicts a control device 10. The control device 10 is in the form of a flashlight and may therefore be operated in a particularly intuitive manner.

The beams 11 emitted by the control device 10 are emitted in the form of truncated cones with an opening angle α. The opening angle α is adjustable by virtue of the user 7 rotating the adjustment ring 16. A size of the selected region 5 may be changed by varying the opening angle α.

The beams 11 in the form of truncated cones are emitted along a central axis MA. The reference point 6 is on this central axis MA.

The user may adjust a distance d between the reference point 6 and the control device 10 by a sliding button 15 of the control device 10. The sliding button 15 and the adjustment ring 16 form a determination unit, in particular.

The user 7 may determine a depth h of the selected region 5 by a voice command. The control device 10 may therefore be operated using a single hand 13. Furthermore, it is possible to provide a haptic input device for adjusting the depth h, for example, a sliding button. Furthermore, a two-dimensional touchpad may also be used to adjust both the distance d and the depth h. In addition, the depth h may also be adjusted in some embodiments by rotating the control device 10 about its longitudinal axis.

In embodiments, the control device 10 also includes an actuation unit for switching the control device 10 on and off and/or an extent unit for selecting an extent of the increase in the distances between the selected parts 14.

Although the present disclosure has been described on the basis of exemplary embodiments, it may be modified in various ways. Instead of the described motor, the object 3 may also be, for example, any desired machine of an industrial installation or an entire industrial installation. The parts 4 of the object 3 may also be arranged inside the object 3 in a different manner to that shown in FIG. 1. The 3-D model 1 may alternatively also be displayed on a normal 3-D screen or in an AR environment. It is also conceivable to display some of the parts 4, (e.g., the parts 4 which have not been selected), with an increased transparency.

The control device 10 may also be in the form of a remote control having a multiplicity of buttons. Alternatively, the control device 10 may also be a movement detection device which detects movements of the user 7. The described control device 10 in the form of a flashlight may also be modified. It may have, for example, various buttons for adjusting the distance d and/or the opening angle α.

It is to be understood that the elements and features recited in the appended claims may be combined in different ways to produce new claims that likewise fall within the scope of the present disclosure. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

While the present disclosure has been described above by reference to various embodiments, it may be understood that many changes and modifications may be made to the described embodiments. It is therefore intended that the foregoing description be regarded as illustrative rather than limiting, and that it be understood that all equivalents and/or combinations of embodiments are intended to be included in this description.

1. A method for displaying a three-dimensional (3-D) model of an object having a multiplicity of parts arranged in original positions, the method comprising:
actuating a control device to select a region of the 3-D model, wherein parts of the multiplicity of parts of the object in the selected region form selected parts; and
displaying the 3-D model in such a manner that the selected parts are displayed in end positions in which the selected parts are moved away from their original positions where distances between the selected parts increase.

2. The method of claim 1, wherein the 3-D model is displayed in such a manner that parts of the multiplicity of parts of the object which are outside the selected region are displayed in their original positions.

3. The method of claim 1, wherein the selected parts are moved away from their original positions when displaying the 3-D model in such a manner that distances between the selected parts and a reference point inside the selected region increase.

4. The method of claim 3, wherein the 3-D model is displayed in a virtual reality (VR) environment and/or an augmented reality (AR) environment.

5. The method of claim 4, wherein the control device emits virtual beams in such a manner that the virtual beams are visible only in the VR environment and/or in the AR environment, and
wherein the virtual beams are used to select the selected region during movement of the control device.

6. The method of claim 5, wherein the virtual beams are emitted by the control device in a form of truncated cones in the VR environment and/or the AR environment, and
wherein a region of the object intersected by the virtual beams forms the selected region.

7. The method of claim 6, wherein the reference point is arranged on a central axis of a truncated cone formed by the virtual beams in a form of truncated cones.

8. The method of claim 1, wherein the control device is actuated in such a manner that:
a position of a reference point is selected;
a distance between the control device and the reference point is selected;
an extent of the increase in the distances between the selected parts is selected; and/or
a size of the selected region is determined.

9. The method of claim 1, further comprising:
actuating the control device in such a manner that the selection of the selected region is canceled; and
displaying the 3-D model in such a manner that the selected parts of the selected region are displayed in their original positions.

10. The method of claim 1, further comprising:
selecting a predetermined part of the selected parts by the control device and/or a further control device.

11. The method of claim 1, wherein the 3-D model is displayed in such a manner that a transparency of at least some of the parts of the multiplicity of parts of the object is increased.

12. A computer program product which, when executed on a program-controlled device, causes the program-controlled device to:
actuate the program-control device to select a region of a three-dimensional (3-D) model of an object having a multiplicity of parts arranged in original positions, wherein parts of the multiplicity of parts of the object in the selected region form selected parts; and
display the 3-D model on a display device in such a manner that the selected parts are displayed in end positions in which the selected parts are moved away from their original positions where distances between the selected parts increase.

13. A system for displaying a 3-D model of an object having of a multiplicity of parts arranged in original positions, the system comprising:
a control device configured to be actuated by a user in such a manner that a region of the 3-D model is selected, wherein the parts of the multiplicity of parts of the object in the selected region form selected parts; and
a display device for displaying the 3-D model in such a manner that the selected parts are displayed in end positions in which the selected parts are moved away from their original positions where distances between the selected parts increase.

14. The system of claim 13, wherein the display device is configured to display the 3-D model in such a manner that parts of the multiplicity of parts of the object which are outside the selected region are displayed in their original positions.

15. The system of claim 13, further comprising:
a control device in a form of a flashlight, wherein the control device comprises:
an actuation unit for switching the control device on and off;
an extent unit for selecting an extent of the increase in the distances between the selected parts;
a selection unit for selecting a predetermined part of the selected parts; and/or
a determination unit for determining a position and/or a size of the selected region.

16. The method of claim 11, wherein the at least some of the parts of the multiplicity of parts of the object comprise parts that are not the selected parts of the multiplicity of parts of the object.

17. The method of claim 1, wherein the 3-D model is displayed in a virtual reality (VR) environment and/or an augmented reality (AR) environment.

18. The method of claim 1, wherein the control device emits virtual beams in such a manner that the virtual beams are visible only in a virtual reality (VR) environment and/or in an augmented reality environment, and
wherein the virtual beams are used to select the selected region during movement of the control device.

19. The method of claim 18, wherein the virtual beams are emitted by the control device in a form of truncated cones in the VR environment and/or the AR environment, and
wherein a region of the object intersected by the virtual beams forms the selected region.

20. The method of claim 19, wherein the selected parts are moved away from their original positions when displaying the 3-D model in such a manner that distances between the selected parts and a reference point inside the selected region increase, and
wherein the reference point is arranged on a central axis of a truncated cone formed by the virtual beams in a form of truncated cones.
